(19) United States
(12) Patent Application Publication
(10) Pub. No.: US 2023/0052173 A1
(43) Pub. Date: Feb. 16, 2023

(54) COMMUNICATION DEVICE AND COMMUNICATION METHOD

(71) Applicant: Panasonic Intellectual Property Corporation of America, Torrance, CA (US)

(72) Inventors: Akihiko NISHIO, Osaka (JP); Yasuaki YUDA, Kanagawa (JP); Tetsuya YAMAMOTO, Kanagawa (JP)

(21) Appl. No.: 17/787,891

(22) PCT Filed: Oct. 28, 2020
(86) PCT No.: PCT/JP2020/040357

§ 371 Date: Jun. 21, 2022

(30) Foreign Application Priority Data
Dec. 26, 2019 (JP) 2019-236799

(51) Int. Cl. H04W 52/14; H04L 5/00

(52) U.S. Cl. CPC H04W 52/14; H04L 5/0048

(57) ABSTRACT

According to the present invention, a base station is provided with: a control circuit that, through non-orthogonal multiplexing, allocates a first transmission power to a first signal corresponding to a first terminal type and allocates a second transmission power to a second signal corresponding to a second terminal type; and a transmission circuit that transmits the first signal and second signal having been non-orthogonally multiplexed.

### TECHNICAL FIELD

The present disclosure relates to a communication apparatus and a communication method.

### BACKGROUND ART

In the standardization of 5G, New Radio access technology (NR) has been specified in 3GPP, and the Release 15 (Rel. 15) specification for NR has been published.

### CITATION LIST

Non-Patent Literature

### NPL 1

3GPP, TR38.811 V15.2.0, “Study on New Radio (NR) to support non terrestrial networks (Release 15),” 2019-09

### SUMMARY OF INVENTION

### Technical Problem

There is scope for further study, however, on a method for improving transmission efficiency of radio communication in radio communication systems.

One non-limiting and exemplary embodiment facilitates providing a communication apparatus and a communication method each capable of improving transmission efficiency of radio communication.

A communication apparatus according to an exemplary embodiment of the present disclosure includes: control circuitry, which, in operation, allocates, in non-orthogonal multiplexing, first transmission power and second transmission power to a first signal and a second signal, respectively, the first signal corresponding to a first terminal type, the second signal corresponding to a second terminal type; and transmission circuitry, which, in operation, transmits the first signal and the second signal that are non-orthogonally multiplexed.

Note that these generic or specific aspects may be achieved by a system, an apparatus, a method, an integrated circuit, a computer program, or a recoding medium, and also by any combination of the system, the apparatus, the method, the integrated circuit, the computer program, and the recoding medium.

According to an exemplary embodiment of the present disclosure, it is possible to improve transmission efficiency of radio communication.

Additional benefits and advantages of the disclosed exemplary embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 illustrates an exemplary architecture of a 3GPP NR system,

FIG. 2 schematically illustrates a functional split between Next Generation—Radio Access Network (NG-RAN) and 5th Generation Core (5GC);

FIG. 3 is a sequence diagram of a Radio Resource Control (RRC) connection setup/reconfiguration procedure;

FIG. 4 schematically illustrates usage scenarios of enhanced Mobile BroadBand (eMBB), massive Machine Type Communications (mMTC), and Ultra Reliable and Low Latency Communications (URLLC);

FIG. 5 is a block diagram illustrating an exemplary 5G system architecture for a non-roaming scenario;

FIG. 6 is a block diagram illustrating a configuration of a. part of a base station according to Embodiment 1;

FIG. 7 is a block diagram illustrating a configuration of a part of a terminal according to Embodiment 1;

FIG. 8 is a block diagram illustrating a configuration example of the base station according to Embodiment 1;

FIG. 9 is a block diagram illustrating a configuration example of the terminal according to Embodiment 1;

FIG. 10 is a block diagram illustrating a configuration example of another terminal according to Embodiment 1;

FIG. 11 is a sequence diagram illustrating an operation example in downlink communication according to Embodiment 1;

FIG. 12 illustrates an example of NOMA multiplexing in the downlink communication according to Embodiment 1;

FIG. 13 is a sequence diagram illustrating an operation example in uplink communication according to Embodiment 1;

FIG. 14 illustrates an example of NOMA multiplexing in the uplink communication according to Embodiment 1;

FIG. 15 illustrates an example of NOMA multiplexing in downlink communication according to Embodiment 2;

FIG. 16 illustrates examples of encoding and modulation of data for Internet of Things

FIG. 17 illustrates an example of NOMA multiplexing in uplink communication according to Embodiment 2; and

FIG. 18 illustrates an exemplary communication timing of data for IoT and data for an aircraft terminal.

### DESCRIPTION OF EMBODIMENTS

Hereinafter, embodiments of the present disclosure will be described in detail with reference to the accompanying drawings.

### 5G NR System Architecture and Protocol Stack

3GPP has been working on the next release for the 5th generation cellular technology (simply called “5G”), including the development of a new radio access technology (NR) operating in frequencies ranging up to 100 GHz. The first version of the 5G standard was completed at the end of 2017, which allows proceeding to 5G NR standard-compliant trials and commercial deployments of terminals (e.g., smartphones).

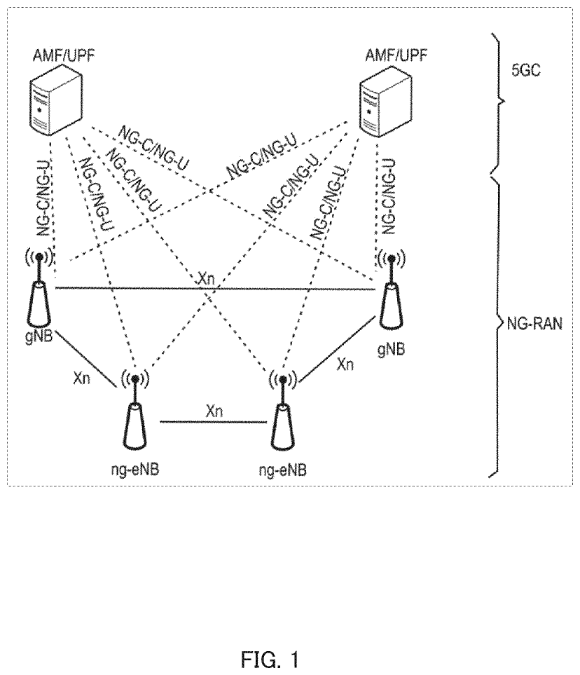

For example, the overall system architecture assumes an NG-RAN (Next Generation-Radio Access Network) that includes gNBs, providing the NG-radio access user plane (SDAP/PDCP/RLC/MAC/PHY) and control plane (RRC) protocol terminations towards the UE. The gNBs are interconnected with each other by means of the Xn interface. The gNBs are also connected by means of the Next Generation (NG) interface to the NGC (Next Generation Core), more specifically to the AMF (Access and Mobility Management Function) (e.g., a particular core entity performing the AMF) by means of the NG-C interface and to the UPF (User Plane Function) (e.g., a particular core entity performing the UPF) by means of the NG-U interface. The NG-RAN architecture is illustrated in FIG. 1 (see e.g., 3GPP TS 38.300 v15.6.0, section 4).

The user plane protocol stack for NR (see e.g., 3GPP TS 38.300, section 4.4.1) includes the PDCP (Packet Data Convergence Protocol, see clause 6.4 of TS 38.300), RLC (Radio Link Control, see clause 6.3 of TS 38.300) and MAC (Medium Access Control, see clause 6.2 of IS 38.300) sublayers, which are terminated in the gNB on the network side. Additionally, a new Access Stratum (AS) sublayer (SDAP, Service Data Adaptation Protocol) is introduced above the PDCP (see e.g., clause 6.5 of 3GPP TS 38.300). A control plane protocol stack is also defined for NR (see for instance TS 38.300, section 4.4.2). An overview of the Layer 2 functions is given in clause 6 of TS 38.300, The functions of the PDCP, RLC, and MAC sublayers are listed respectively in clauses 6.4, 6.3, and 6.2 of TS 38.300. The functions of the RRC layer are listed in clause 7 of TS 38.300.

For instance, the Medium-Access-Control layer handles logical-channel multiplexing, and scheduling and scheduling-related functions, including handling of different numerologies.

The physical layer (PHY) is for example responsible for coding, PHY HARQ processing, modulation, multi-antenna processing, and mapping of the signal to the appropriate physical time-frequency resources. The physical layer also handles mapping of transport channels to physical channels. The physical layer provides services to the MAC layer in the form of transport channels. A physical channel corresponds to the set of time-frequency resources used for transmission of a particular transport channel, and each transport channel is mapped to a corresponding physical channel. Examples of the physical channel include a Physical Random Access Channel (PRACH), a Physical Uplink Shared Channel (PUSCH), and a Physical Uplink Control Channel (PUCCH) as uplink physical channels, and a Physical Downlink Shared Channel (PDSCH), a Physical Downlink Control Channel (PDCCH), and a Physical Broadcast Channel (PBCH) as downlink physical channels.

Use cases/deployment scenarios for NR could include enhanced mobile broadband (eMBB), ultra-reliable low-latency communications (URLLC), and massive machine type communication (mMTC), which have diverse requirements in terms of data rates, latency, and coverage. For example, eMBB is expected to support peak data rates (20 Gbps for downlink and 10 Gbps for uplink) and user-experienced data rates on the order of three times what is offered by IMT-Advanced. On the other hand, in case of URLLC, the tighter requirements are put on ultra-low latency (0.5 ms for UL and DL each for user plane latency) and high reliability (1-10-5 within 1 ms). Finally, mMTC may preferably require high connection density (1,000,000 devices/km² in an urban environment), large coverage in harsh environments, and extremely long-life battery for low cost devices (15 years).

Therefore, the OFDM numerology (e.g., subcarrier spacing, OFDM symbol duration, cyclic prefix (CP) duration, and number of symbols per scheduling interval) that is suitable for one use case might not work well for another. For example, low-latency services may preferably require a shorter symbol duration (and thus larger subcarrier spacing) and/or fewer symbols per scheduling interval (aka, TTI) than an mMTC service. Furthermore, deployment scenarios with large channel delay spreads may preferably require a longer CP duration than scenarios with short delay spreads. The subcarrier spacing should be optimized accordingly to retain the similar CP overhead. NR may support more than one value of subcarrier spacing. Correspondingly, subcarrier spacings of 15 kHz, 30 kHz, and 60 kHz. . . . are being considered at the moment. The symbol duration Tu and the subcarrier spacing Δf are directly related through the formula Δf=1/Tu. In a similar manner as in LTE systems, the term “resource element” can be used to denote a minimum resource unit being composed of one subcarrier for the length of one OFDM/SC-FDMA symbol.

In the new radio system 5G-NR for each numerology and each carrier, resource grids of subcarriers and OFDM symbols are defined respectively for uplink and downlink. Each element in the resource grids is called a resource element and is identified based on the frequency index in the frequency domain and the symbol position in the time domain (see 3GPP TS 38.211 v15.6.0).

### Functional Split Between NG-RAN and 5GC in 5G NR

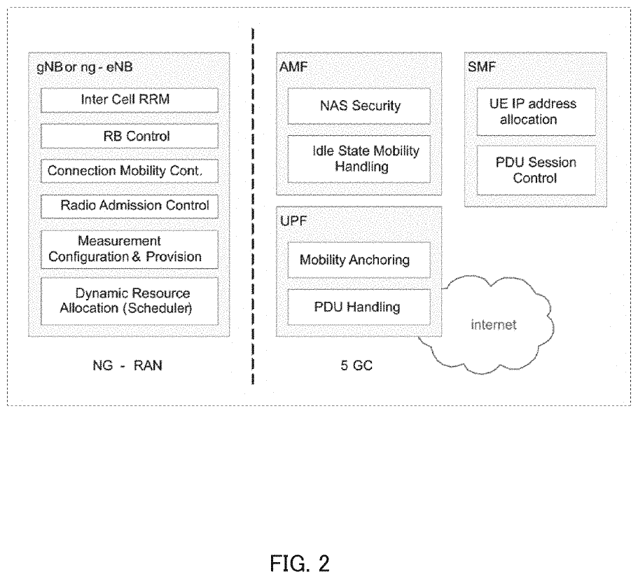

FIG. 2 illustrates the functional split between the NG-RAN and the 5GC. A logical node of the NG-RAN is gNB or ng-eNB. The 5GC includes logical nodes AMF, UPF, and SMF.

For example, gNB and ng-eNB hosts the following main functions:
Radio Resource Management functions such as Radio Bearer Control, Radio Admission Control, Connection Mobility Control, and dynamic allocation (scheduling) of both uplink and downlink resources to a UE;
IP header compression, encryption, and integrity protection of data;
Selection of an AMF during UE attachment in such a case when no routing to an AMF can be determined from the information provided by the UE;
Routing user plane data towards the UPF;
Routing control plane information towards the AMF;
Connection setup and release;
Scheduling and transmission of paging messages;
Scheduling and transmission of system broadcast information (originated from the AMF or an operation management maintenance function (OAM: Operation, Admission, Maintenance));
Measurement and measurement reporting configuration for mobility and scheduling;
Transport level packet marking in the uplink;
Session management;
Support of network slicing;
QoS flow management and mapping to data radio bearers;
Support of UE; in the RRC_INACTIVE state;
Distribution function for NAS messages;
Radio access network sharing;
Dual connectivity; and
Tight interworking between NR and E-UTRA.

The Access and Mobility Management Function (AMF) hosts the following main functions:
Function of Non-Access Stratum (NAS) signaling termination;
NAS signaling security;
Access Stratum (AS) security control;
Inter-Core Network (CN) node signaling for mobility between 3GPP access networks;
Idle mode UE reachability (including control and execution of paging retransmission);
Registration area management;
Support of intra-system and inter-system mobility;
Access authentication;
Access authorization including check of roaming rights;
Mobility management control (subscription and policies);
Support of network slicing; and
Session Management Function (SMF) selection.

In addition, the User Plane Function (UPF) hosts the following main functions:
Anchor Point for intra-/inter-RAT mobility (when applicable);
External Protocol Data Unit (PDU) session point for interconnection to a data network;
Packet routing and forwarding;
Packet inspection and a user plane part of Policy rule enforcement;
Traffic usage reporting;
Uplink classifier to support routing traffic flows to a data network;
Branching point to support multi-homed PDU session;
QoS handling for user plane e.g., packet filtering, gating, UL/DL rate enforcement);
Uplink traffic verification (SDF to QoS flow mapping); and
Function of downlink packet buffering and downlink data indication triggering.

Finally, the Session Management Function (SMF) hosts the following main functions:
Session management;
UE IP address allocation and management;
Selection and control of UPF;

Configuration function for traffic steering at the User Plane Function (UPF) to route traffic to a proper destination;
Control part of policy enforcement and QoS; and
Downlink data indication.

### RRC Connection Setup and Reconfiguration Procedure

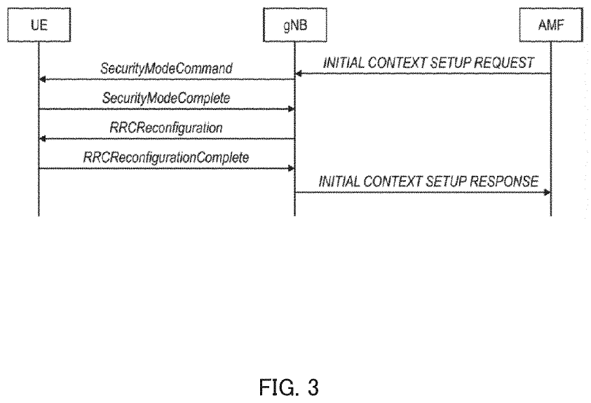

FIG. 3 illustrates some interactions between a UE, gNB, and AMF (a 5GC Entity) performed in the context of a transition of the UE from RRC_IDLE to RRC_CONNECTED for the NAS part (see TS 38 300 v15.6.0).

The RRC is higher layer signaling (protocol) used to configure the UE and gNB. With this transition, the AMF prepares UE context data (which includes, for example, a PDU session context, security key, UE Radio Capability, UE Security Capabilities, and the like) and sends it to the gNB with an INITIAL CONTEXT SETUP REQUEST. Then, the gNB activates the AS security with the UE. This activation is performed by the gNB transmitting to the UE a SecurityModeCommand message and by the UE responding to the gNB with the Security ModeComplete message. Afterwards, the gNB performs the reconfiguration to setup the Signaling Radio Bearer 2 (SRB2) and Data Radio Bearer(s) (DRB(s)) by means of transmitting to the UE the RRCReconfiguration message and, in response, receiving by the gNB the RRCReconfigurationComplete from the UE. For a signaling-only connection, the steps relating to the RRCReconfiguration are skipped since SRB2 and DRBs are not set up. Finally, the gNB indicates the AMF that the setup procedure is completed with INITIAL CONTEXT SETUP RESPONSE.

Thus, the present disclosure provides a 5th Generation Core (5GC) entity (e.g., AMF, SMF, or the like) including control circuitry, which, in operation, establishes a Next Generation (NG) connection with a gNodeB, and a transmitter, which in operation, transmits an initial context setup message to the gNodeB via the NG connection such that a signaling radio bearer between the gNodeB and a User Equipment (UE) is set up. Specifically, the gNodeB transmits Radio Resource Control (RRC) signaling including a resource allocation configuration Information Element (IE) to the UE via the signaling radio bearer. Then, the UE performs an uplink transmission or a downlink reception based on the resource allocation configuration.

### Usage Scenarios of IMT for 2020 and Beyond

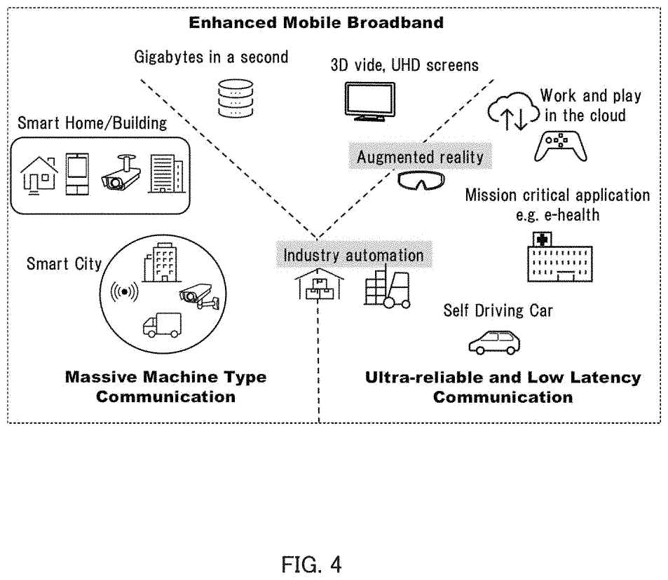

FIG. 4 illustrates some of the use cases for 5G NR. In 3rd generation partnership project new radio (3GPP NR), three use cases are being considered that have been envisaged to support a wide variety of services and applications by IMT-2020. The specification for the phase 1 of enhanced mobile-broadband (eMBB) has been concluded. In addition to further extending the eMBB support, the current and future work would involve the standardization for ultra-reliable and low-latency communications (URLLC) and massive machine-type communications (mMTC). FIG. 4 illustrates some examples of envisioned usage scenarios for IMT for 2020 and beyond (see e.g., ITU-R M.2083 FIG. 2).

The URLLC use case has stringent requirements for capabilities such as throughput, latency and availability. The URLLC use case has been envisioned as one of the enablers for future vertical applications such as wireless control of industrial manufacturing or production processes, remote medical surgery, distribution automation in a smart grid, transportation safety. Ultra-reliability for URLLC is to be supported by identifying the techniques to meet the requirements set by TR 38.913. For NR URLLC in Release 15, key requirements include a target user plane latency of 0.5 ms for UL (uplink) and 0.5 ms for DL (downlink). The general URLLC requirement for one transmission of a packet is a block error rate (BLER) of 1E-5 for a packet size of 32 bytes with a user plane latency of 1 ms.

From the physical layer perspective, reliability can be improved in a number of possible ways. The current scope for improving the reliability involves defining separate CQI tables for URLLC, more compact DCI formats, repetition of PDCCH, or the like. However, the scope may widen for achieving ultra-reliability as the NR becomes more stable and developed (for NR URLLC key requirements). Particular use cases of NR URLLC in Rel. 15 include Augmented Reality/Virtual Reality (AR/VR), e-health, e-safety, and mission-critical applications.

Moreover, technology enhancements targeted by NR URLLC aim at latency improvement and reliability improvement. Technology enhancements for latency improvement include configurable numerology, non slot-based scheduling with flexible mapping, grant free (configured grant) uplink, slot-level repetition for data channels, and downlink pre-emption. Pre-emption means that a transmission for which resources have already been allocated is stopped, and the already allocated resources are used for another transmission that has been requested later, but has lower latency/higher priority requirements. Accordingly, the already granted transmission is pre-empted by a later transmission. Pre-emption is applicable independent of the particular service type. For example, a transmission for a service-type A (URLLC) may be pre-empted by a transmission for a service type B (such as eMBB). Technology enhancements with respect to reliability improvement include dedicated CQI/MCS tables for the target BLER of 1E-5.

The use case of mMTC (massive machine type communication) is characterized by a very large number of connected devices typically transmitting a relatively low volume of non-delay sensitive data. Devices are required to be low cost and to have a very long battery life. From NR perspective, utilizing very narrow bandwidth parts is one possible solution to have power saving from UE perspective and enable long battery life.

As mentioned above, it is expected that the scope of reliability in NR becomes wider. One key requirement to all the cases, for example, for URLLC and mMTC, is high reliability or ultra-reliability. Several mechanisms can improve the reliability from radio perspective and network perspective. In general, there are a few key potential areas that can help improve the reliability. Among these areas are compact control channel information, data/control channel repetition, and diversity with respect to frequency, time and/or the spatial domain. These areas are applicable to reliability improvement in general, regardless of particular communication scenarios.

For NR URLLC, further use cases with tighter requirements have been envisioned such as factory automation, transport industry and electrical power distribution. The tighter requirements are higher reliability (up to 10-6 level), higher availability, packet sizes of up to 256 bytes, time synchronization up to the extent of a few μs (where the value can be one or a few μs depending on frequency range and short latency on the order of 0.5 to 1 ms (in particular a target user plane latency of 0.5 ms), depending on the use cases).

Moreover, for NR URLLC, several technology enhancements from physical layer perspective have been identified. Among these are PDCCH (Physical Downlink Control Channel) enhancements related to compact DCI, PDCCH repetition, increased PDCCH monitoring. Moreover, UCI (Uplink Control Information) enhancements are related to enhanced HARQ (Hybrid Automatic Repeat Request) and CSI feedback enhancements. Also PUSCH enhancements related to mini-slot level hopping and retransmission/repetition enhancements are possible. The term “mini-slot” refers to a Transmission Time Interval (TTI) including a smaller number of symbols than a slot (a slot comprising fourteen symbols).

### QoS Control

The 5G QoS (Quality of Service) model is based on QoS flows and supports both QoS flows that require guaranteed flow bit rate (GBR QoS flows) and QoS flows that do not require guaranteed flow bit rate (non-GBR QoS Flows). At NAS level, the QoS flow is thus the finest granularity of QoS differentiation in a PDU session. A QoS flow is identified within a PDU session by a QoS flow ID (QFI) carried in an encapsulation header over NG-U interface.

For each UE, 5GC establishes one or more PDU sessions. For each UE, the NG-RAN establishes at least one Data Radio Bearer (DRB) together with the PDU session, e.g., as illustrated above with reference to FIG. 3. Further, additional DRB(s) for QoS flow(s) of that PDU session can be subsequently configured (it is up to NG-RAN when to do so). The NG-RAN maps packets belonging to different PDU sessions to different DRBs. NAS level packet filters in the UE and in the 5GC associate UL and DL packets with QoS Flows, whereas AS-level mapping rules in the UE and in the NG-RAN associate UL and DL QoS Flows with DRBs.

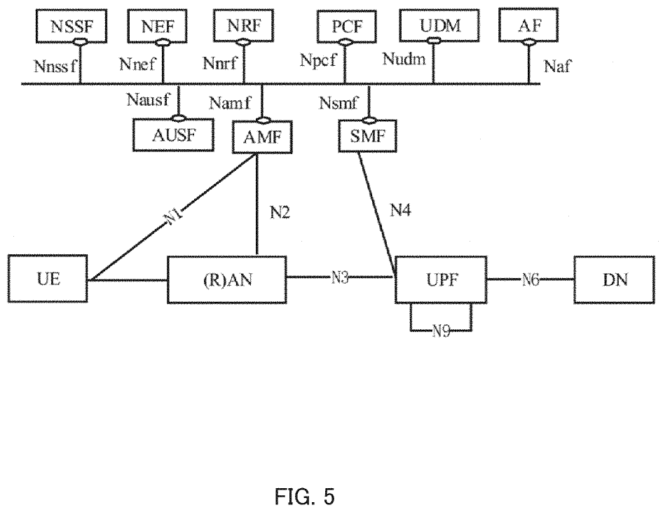

FIG. 5 illustrates a 5G NR non-roaming reference architecture (see TS 23.501 v16.1.0, section 4.23). An Application Function (AF) (e.g., an external application server hosting 5G services, exemplarily described in FIG. 4) interacts with the 3GPP Core Network in order to provide services, for example to support application influencing on traffic routing, accessing Network Exposure Function (NEF) or interacting with the policy framework for policy control (e.g., QoS control) (see Policy Control Function, PCF). Based on operator deployment, Application Functions considered to be trusted by the operator can be allowed to interact directly with relevant Network Functions. Application Functions not allowed by the operator to access directly the Network Functions use the external exposure framework via the NEF to interact with relevant Network Functions.

FIG. 5 illustrates further functional units of the 5G architecture, namely Network Slice Selection Function (NSSF), Network Repository Function (NRF), Unified Data Management (UDM), Authentication Server Function (AUSF). Access and Mobility Management Function (AMF), Session Management Function (SMF), and Data Network (DN, e.g., operator services, Internet access, or third party services). All of or a part of the core network functions and the application services may be deployed and running on cloud computing environments.

In the present disclosure, thus, an application server (e.g., AF of the 5G architecture), is provided that includes: a transmitter, which in operation, transmits a request containing a QoS requirement for at least one of URLLC, eMMB and mMTC services to at least one of functions (such as NEF, AMF, SMF, PCF, and UPF) of the 5GC to establish a PDU session including a radio bearer between a gNodeB and a UE in accordance with the QoS requirement; and control circuitry, which, in operation, performs the services using the established PDU session.

### Extension to Non-Terrestrial Network (NTN)

Rel. 15 is the specification of a radio access technology for a terrestrial network, for example. In NR, extension to a Non-Terrestrial Network (NTN) such as communication using a satellite or a high-altitude pseudolite (High-altitude platform station (HAPS)) is discussed (e.g., see Non-Patent Literature (hereinafter referred to as “NPL”) 1). An example of NTN include communication (e.g., satellite communication) for aircrafts or ships.

In the following, the 5G NR technology extended to NTN may be called “5G NTN.”

In an NTN environment, a coverage area (e.g., one or more cells) of a satellite for a terminal on the ground or a terminal installed on an aircraft (hereinafter, may be also referred to as “aircraft terminal”) is formed by, for example, beams transmitted from the satellite.

For example, the satellite communications are used for communication between an aircraft and a terrestrial network. As an example, an aircraft terminal can perform Internet-access (or broadband communications).

Further, for example, utilization of Internet of Things (IoT) terminals (or may be also referred to as IoT devices) such as sensors anywhere on the ground has been discussed. Examples of utilizing the IoT terminals include a position management and control of a container or heavy machinery, and/or sensing and monitoring of natural conditions such as a river or a forest. Incidentally, since a coverage area of the ground network is mainly formed in living and/or activity areas of people; thus, the satellite communications may be utilized for communication for IoT terminals in a remoted area outside the coverage area of the ground network, for example.

5G-NR is applicable to, for example, communication traffic with various properties such as broadband communications (e.g., enhanced Mobile Broadband: eMBB) or IoT communications (e.g., massive Machine Type Communication: mMTC). 5G NTN is also applicable to communication for aircrafts (e.g., broadband communications) and the communication for IoT terminals.

Incidentally, a beam area formed by the satellite can reach, for example, several hundred kilometers, and thus, accommodation of more IoT terminals can be assumed in the beam area formed by the satellite.

However, in the NTN environment, a method for improving transmission efficiency of the communication for aircrafts and the communication for IoT terminals has not been fully studied.

Hence, in an exemplary embodiment of the present disclosure, a description will be given of the method for improving transmission efficiency of the communication for aircrafts and the communication for IoT terminals. According to an exemplary embodiment of the present disclosure, it is possible to suppress a reduction in communication throughput for aircrafts and thus to accommodate the more IoT terminals.

### Multiple Access Scheme

A multiple access scheme in a cellular network include, for example, orthogonal multiple access (OMA) and non-orthogonal multiple access (NOMA). For example, OMA transmits data to users by means of different time-and frequency-resources. On the other hand, NOMA transmits data power differences, to users, while the data is superimposed on identical time-and frequency-resources, for example.

In NOMA, a reception device removes (cancels), in the superimposed signal, a signal with large power (i.e., interference signal) by, for example, a serial interference canceller (SIC) to extract a signal with small power (i.e., desired signal). Another reception device regards a signal with small power in the superimposed signal as noise and decodes a signal with large power. In NOMA, transmission efficiency can be improved as compared to OMA by utilizing identical time-and frequency-resources.

Incidentally, for example, in the satellite communications, a propagation path of an aircraft (e.g., propagation path between satellite and aircraft terminal) may be an environment with less reflected objects and less fading (e.g., additive white gaussian noise: AWGN environment) as compared to a propagation path of a terminal on the ground. Thus, in the propagation path of the aircraft, a received signal is unlikely to be distorted in the aircraft or satellite. Consequently, in NOMA the accuracy of interference cancellation by the SIC can be improved in the communication for aircrafts.

On the other hand, for example, in the satellite communications, a propagation path of an IoT terminal (e.g., propagation path between satellite and IoT terminal) may be an environment susceptible to a reflected object on the ground (e.g., multipath environment) as compared to the propagation path of the aircraft. Thus, in the propagation path of the IoT terminal, a received signal is likely to be distorted in the IoT terminal or satellite. In addition, in the propagation path of the IoT terminal, the received signal may be attenuated by natural effects such as a cloud or rainfall. Consequently, in NOMA, the accuracy of interference cancellation by the SIC in the communication for IoT terminals tends to be deteriorated.

In an exemplary embodiment of the present disclosure, therefore, NOMA multiplexing is performed between terminals of different types (may be-referred to as “different terminal types”). By way of example, as described above, a signal for the aircraft terminal having the good-quality propagation path and a signal for the IoT terminal prone to quality-deterioration of propagation path are subjected to the NOMA multiplexing. As a result, for example, it is possible to suppress a reduction in communication throughput for aircrafts and thus to accommodate the more IoT terminals.

### Embodiment 1

### Overview of Radio Communication System

A radio communication system according to an embodiment of the present disclosure includes at least, for example, base station 100, terminal 200, and terminal 300. The radio communication system may be, for example, a satellite communication system in an NTN environment or may be another radio communication system. Base station 100, terminal 200, and terminal 300 are exemplary communication apparatuses.

For example, terminal 200 may be an aircraft terminal, and terminal 300 may be an IoT terminal.

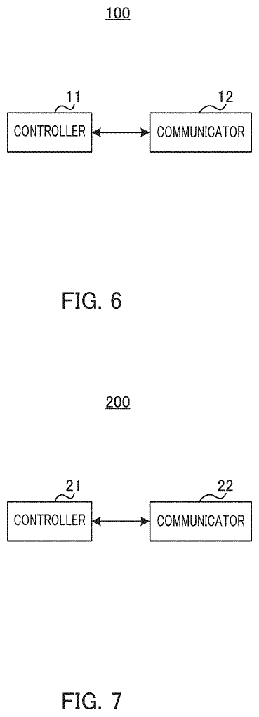

FIG. 6 is a block diagram illustrating an exemplary configuration of a part of base station 100 according to the embodiment of the present disclosure. In base station 100 illustrated in FIG. 6, controller 11 (e.g., corresponding to control circuitry), in the non-orthogonal multiplexing (e.g., NOMA multiplexing), allocates the first transmission power to the first signal corresponding to the first terminal type and allocates the second transmission power to the second signal corresponding to the second terminal type. Communicator 12 (e.g., corresponding to communication circuitry) transmits the first signal and the second signal that have been non-orthogonally multiplexed.

Additionally, in base station 100 illustrated in FIG. 6, communicator 12 (e.g., corresponding to reception circuitry) receives a non-orthogonal multiplexed signal. Controller 11 (corresponding to control circuitry) removes, in the non-orthogonal multiplexed signal, either one of the first signal of the first received power corresponding to the first terminal type or the second signal of the second received power corresponding to the second terminal type.

FIG. 7 is a block diagram illustrating an exemplary configuration of a part of terminal 200 according to the embodiment of the present disclosure. In terminal 200 illustrated in FIG. 7, communicator 22 (e.g., corresponding to reception circuitry) receives a non-orthogonal multiplexed signal. Controller 21 (corresponding to control circuitry) removes, in the non-orthogonal multiplexed signal, either one of the first signal of the first received power corresponding to the first terminal type or the second signal of the second received power corresponding to the second terminal type.

### Configuration of Base Station

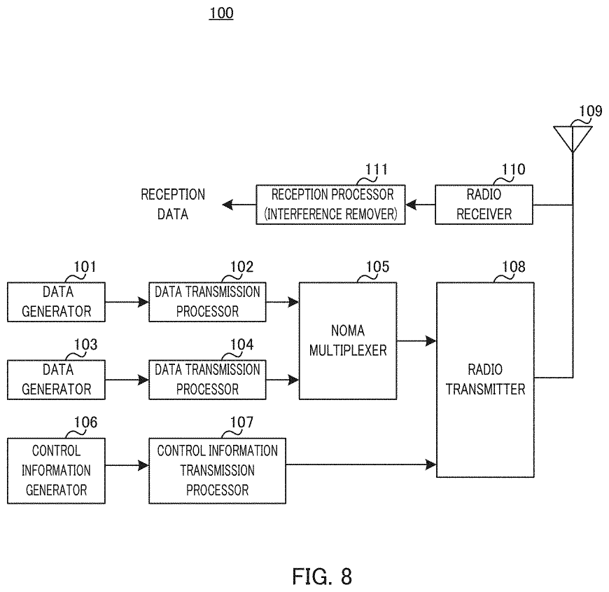

FIG. 8 is a block diagram illustrating a configuration example of base station 100. Base station 100 illustrated in FIG. 8 includes, for example, data generator 101, data transmission processor 102, data generator 103, data transmission processor 104, NOMA multiplexer 105, control information generator 106, control information transmission processor 107, radio transmitter 108, antenna 109, radio receiver 110, and reception processor (or interference remover) 111.

Incidentally, for example, data generators 101 and 103, data transmission processors 102 and 104, NOMA multiplexer 105, control information generator 106, control information transmission processor 107, and reception processor 111 that are illustrated in FIG. 8 may correspond to controller 11 illustrated in FIG. 6, and radio transmitter 108, antenna 109, and radio receiver 110 that are illustrated in FIG. 8 may correspond to communicator 12 illustrated in FIG. 6.

Data generator 101 generates, for example, user data directed to an aircraft terminal (e.g., terminal 200) (hereinafter also referred to as “aircraft-directed data”) and outputs the generated data signal to data transmission processor 102.

Data transmission processor 102 performs error correction encoding and modulation such as Quadrature Phase Shift Keying (QPSK) or 16 Quadrature Amplitude Modulation (16QAM) on the data signal input from data generator 101 and generates a modulation signal. Data transmission processor 102 outputs the generated modulation signal to NOMA multiplexer 105.

Data generator 103 generates, for example, user data directed to an IoT terminal (e.g., terminal 300) (hereinafter also referred to as “IoT-directed data”) and outputs the generated data signal to data transmission processor 104.

Data transmission processor 104 performs error correction encoding and modulation such as QPSK or 16QAM on the data signal input from data generator 103 and generates a modulation signal. Data transmission processor 104 outputs the generated modulation signal to NOMA multiplexer 105.

NOMA multiplexer 105 performs the NOMA multiplexing on the modulation signal input from data transmission processor 102 (e.g., aircraft-directed data) and the modulation signal input from data transmission processor 104 (e.g., IoT-directed data). For example, NOMA multiplexer 105 performs a power configuration for the aircraft-directed data and the IoT-directed data and thus superimposes them on the identical time-and frequency-resources. For example, NOMA multiplexer 105 may configure, for the IoT-directed data, transmission power larger than that for the aircraft-directed data. NOMA multiplexer 105 may also perform terminal-specific or terminal-type-specific scrambling for, for example, the aircraft-directed data and the IoT-directed data, respectively. NOMA multiplexer 105 outputs, to radio transmitter 108, a signal in which the aircraft-directed data and the IoT-directed data are superimposed.

Control information generator 106 generates, for example, a control signal including information such as system information or control information relating to each of terminal 200 and terminal 300 (e.g., individual control information for data allocation), and outputs the generated control signal to control information transmission processor 107.

The control information may include, for example, information indicating allocation of the identical time-and frequency-resources to the IoT terminal (e.g., terminal 300) and the aircraft terminal (e.g., terminal 200). Further, the control information directed to the aircraft terminal may include, for example, information indicating whether the IoT-directed data is superimposed or information such as modulation, a coding rate, a reference signal pattern or a scrambling sequence of the data for the IoT terminal (i.e., information relating to SIC processing).

Control information transmission processor 107 performs error correction encoding and modulation on the control signal input from control information generator 106 and generates a modulation signal. Control information transmission processor 107 outputs the generated modulation signal to radio transmitter 108.

Radio transmitter 108 performs radio transmission processing such as D/A conversion, up-conversion, amplification, or the like on the signal input from NOMA multiplexer 105 and the signal input from control information transmission processor 107, and transmits, from antenna 109, the radio signal resulting from the radio transmission processing.

Radio receiver 110 performs radio reception processing such as down-conversion, A/D conversion, or the like on the data signal from at least one of the aircraft terminal (terminal 200) and the IoT terminal (terminal 300) received via antenna 109, and outputs, to reception processor 111, the received signal resulting from the radio reception processing. For example, a signal to be received at base station 100 may include signals transmitted from the aircraft terminal and the IoT terminal in the identical time-and frequency-resources (e.g., NOMA multiplexed signal).

Reception processor 111 performs, for example, reception processing such as channel estimation, descrambling, demodulation, and decoding on the received signal from the aircraft terminal, and obtains received data from the aircraft terminal.

Further, reception processor 111 performs, for example, interference removal reception (e.g., SIC processing) when performing data reception processing on the received signal from the IoT terminal. For example, reception processor 111 performs processes such as encoding, modulation, and multiplying a channel coefficient on the obtained received data from the aircraft terminal, and generates a replica of the received signal (hereinafter may be also referred to as a “received signal replica”). Reception processor 111 subtracts the received signal replica (i.e., removes aircraft-directed data) from the received signal input from radio receiver 110 so as to obtain the received signal from the IoT terminal. Reception processor 111 demodulates and decodes the obtained received signal from the IoT terminal and obtains received data from the IoT terminal.

### Configuration of Terminal 200

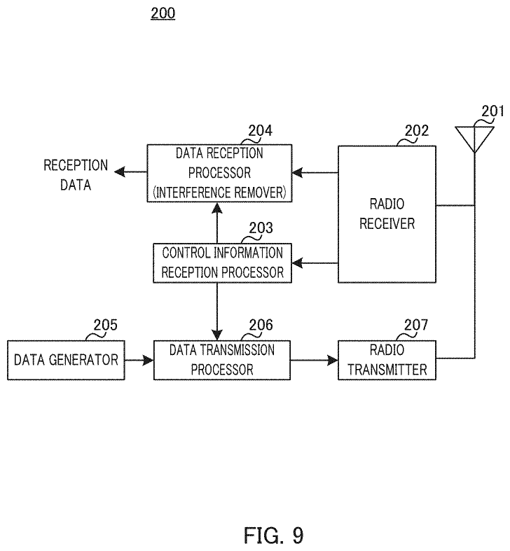

FIG. 9 is a block diagram illustrating a configuration example of terminal 200 (e.g., aircraft terminal). Terminal 200 illustrated in FIG. 9 performs interference removal (cancellation) (e.g., SIC processing) when performing the data reception processing.

Terminal 200 illustrated in FIG. 9 includes, for example, antenna 201, radio receiver 202, control information reception processor 203, data reception processor (or interference remover) 204, data generator 205. data transmission processor 206, and radio transmitter 207.

Radio receiver 202 performs radio reception processing such as down-conversion, A/D conversion, or the like on the signal from base station 100 received via antenna 201. Radio receiver 202, in the received signal resulting from the radio reception processing, outputs a control signal to control information reception processor 203 and outputs a data signal to data reception processor 204.

Here, the data signal received at terminal 200 may include, for example, a signal in which the aircraft-directed data and the IoT-directed data are superimposed in the identical time-and frequency-resources (e.g., NOMA multiplexed signal).

Control information reception processor 203 performs reception processing such as channel estimation, demodulation, and decoding on the control signal input from radio receiver 202, and obtains resource allocation information for at least one of downlink and uplink. For example, control information reception processor 203 outputs the downlink resource allocation information to data reception processor 204 and the uplink resource allocation information to data transmission processor 206.

Data reception processor 204 performs, for example, interference removal reception (e.g., SIC processing) when performing data reception processing. For example, data reception processor 204 performs reception processing such as channel estimation, descrambling, demodulation, and decoding on the signal for the IoT terminal (terminal 300) in the data signal input from radio receiver 202, and obtains IoT-directed received data. Further, data reception processor 204 performs processes such as encoding, modulation, and multiplying a channel coefficient on the IoT-directed received data, and generates a received signal replica. Data reception processor 204 then subtracts the received signal replica (i.e., removes IoT-directed data) from the received signal input from radio receiver 202 so as to obtain received data directed to the aircraft terminal (terminal 200).

Note that, data reception processor 204 may perform the reception processing according to, for example, the time-and frequency-resources, a modulation scheme, or an encoding method that are included in the downlink resource allocation information input from control information reception processor 203. Data reception processor 204 may output, for example, the received data directed to the aircraft to a subsequent application processor (not illustrated). Data reception processor 204 may also discard the obtained IoT-directed received data, for example.

Data generator 205 generates, for example, a data signal including user data (e.g., aircraft-directed data) and outputs the generated data signal to data transmission processor 206.

Data transmission processor 206 performs error correction encoding and modulation on the data signal input from data generator 205 and generates a modulation signal. For example, data transmission processor 206 may perform the error correction encoding and the modulation such as QPSK or 16QAM, based on the uplink resource allocation information input from control information reception processor 203. Data transmission processor 206 outputs the generated modulation signal to radio transmitter 207.

Radio transmitter 207 generates a transmission frame, for the signal input from data transmission processor 206, by mapping to time-and frequency-resources, performs radio transmission processing such as D/A conversion, up-conversion, amplification, or the like on the transmission frame, and thereby transmits, from antenna 201, the radio signal resulting from the radio transmission processing.

### Configuration of Terminal 300

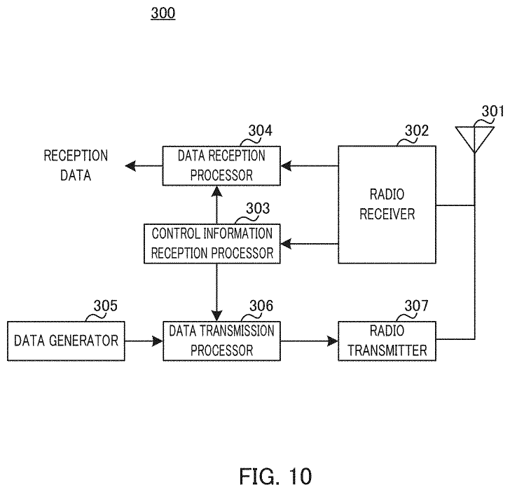

FIG. 10 is a block diagram illustrating a configuration example of terminal 300 (IoT terminal). Terminal 300 illustrated in FIG. 10 does not perform interference removal (e.g., SIC processing) when performing data reception processing. In other words, terminal 300 may not include an interference remover.

Terminal 300 illustrated in FIG. 10 includes, for example, antenna 301, radio receiver 302, control information reception processor 303, data reception processor 304, data generator 305, data transmission processor 306, and radio transmitter 307.

Radio receiver 302 performs radio reception processing such as down-conversion, A/D conversion, or the like on the signal from base station 100 received via antenna 301. Radio receiver 302, in the received signal resulting from the radio reception processing, outputs a control signal to control information reception processor 303 and outputs a data signal to data reception processor 304.

Here, the data signal received at terminal 200 may include, for example, a signal in which the aircraft-directed data and the IoT-directed data are superimposed in the identical time-and frequency-resources (e.g., NOMA multiplexed signal).

Control information reception processor 303 performs reception processing such as channel estimation, demodulation, and decoding on the control signal input from radio receiver 302, and obtains resource allocation information for at least one of downlink and uplink. For example, control information reception processor 303 outputs the downlink resource allocation information to data reception processor 304 and the uplink resource allocation information to data transmission processor 306.

Data reception processor 304 performs reception processing such as channel estimation, descrambling, demodulation, and decoding on the data signal input from radio receiver 302, and obtains IoT-directed received data. Note that, data reception processor 304 may perform the reception processing according to, for example, the time-and frequency-resources, a modulation scheme, or an encoding method that are included in the downlink resource allocation information input from control information reception processor 303. Data reception processor 304 may output, for example, the IoT-directed received data. to a subsequent application processor (not illustrated).

Data generator 305 generates, for example, a data signal including user data (e.g., IoT-directed data) and outputs the generated data signal to data transmission processor 306.

Data transmission processor 306 performs error correction encoding and modulation on the data signal input from data generator 305 and generates a modulation signal. For example, data transmission processor 306 may perform the error correction encoding and the modulation such as QPSK or 16QAM, based on the uplink resource allocation information input from control information reception processor 303. Data transmission processor 306 outputs the generated modulation signal to radio transmitter 307.

Radio transmitter 307 generates a transmission frame, for the signal input from data. transmission processor 306, by mapping to time-and frequency-resources, performs radio transmission processing such as D/A conversion, up-conversion, amplification, or the like on the transmission frame, and thereby transmits, from antenna 301, the radio signal resulting from the radio transmission processing.

### Operation Examples of Base Station 100, Terminal 200, and Terminal 300

A description will be given of operation examples of base station 100, terminal 200, and terminal 300 mentioned above.

First, downlink communication will be described.

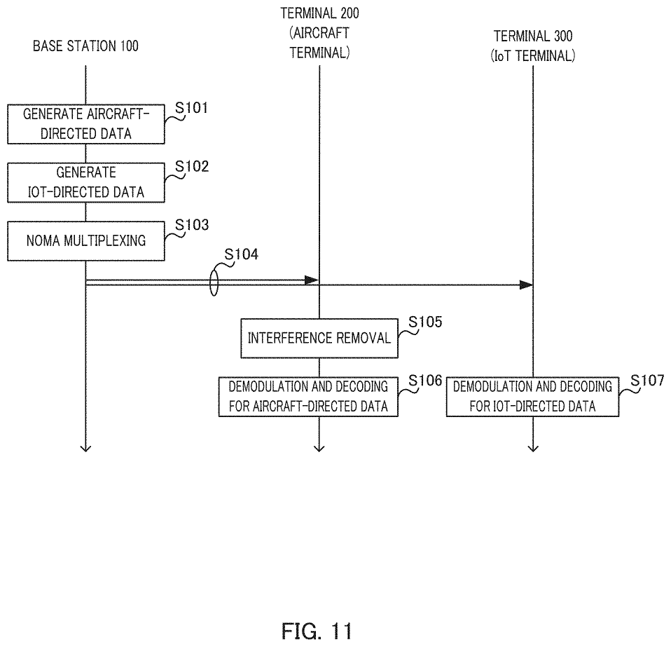

FIG. 11 is a sequence diagram illustrating operation examples of base station 100, terminal 200 (e.g., aircraft terminal), and terminal 300 (e.g., IoT terminal) in the downlink communication.

In FIG. 11, base station 100 generates the aircraft-directed data and the IoT-directed data (S101 and S102). A generation order of the aircraft-directed data and the IoT-directed data (i.e., generation timing) is not limited to the order illustrated in FIG. 11, and the data may be generated in the reverse order or simultaneously.

Base station 100 NOMA multiplexes the aircraft-directed data and the IoT-directed data (S103) and thus transmits the NOMA multiplexed signal to terminal 200 and terminal 300, respectively (S104).

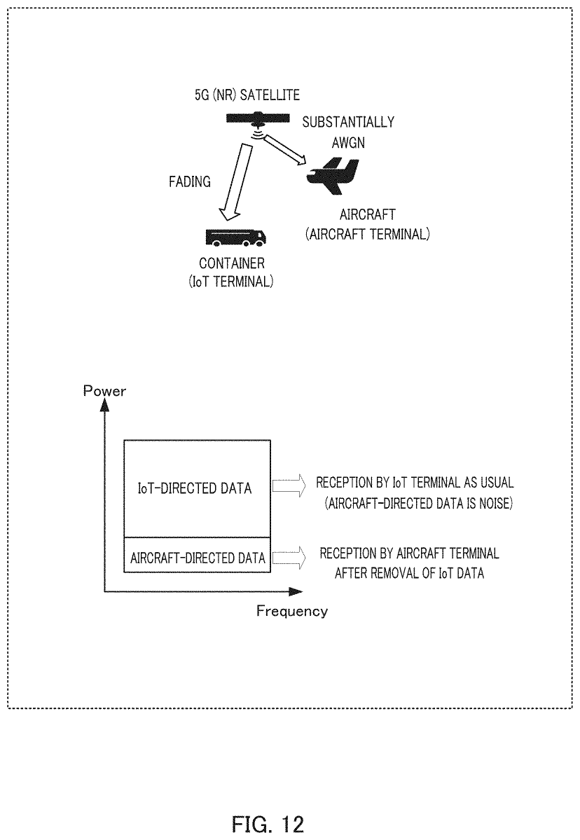

FIG. 12 illustrates an exemplary signal having the aircraft-directed data and the IoT-directed data superimposed thereon to be transmitted in base station 100.

For example, in a propagation path between a satellite (e.g., 5G (NR) satellite) and an IoT terminal (e.g., container), the IoT terminal easily receives an attenuated or distorted signal due to natural effects such as a cloud or rainfall or effects such as reflected waves on the ground, as compared to a propagation path between the satellite and an aircraft terminal. On the other hand, in the propagation path between the satellite and the aircraft terminal, a masking object or a reflected object is less likely to be present in the surroundings, and thus the aircraft terminal easily receives a signal with less attenuation or distortion, as compared to the propagation path between the satellite and the IoT terminal.

In other words, in the downlink, received quality (e.g., Signal to Interference and Noise Ratio: SINR) in the aircraft terminal is likely to be high compared with received quality in the IoT terminal.

Hence, base station 100 configures transmission power for the IoT-directed data to be higher than that for the aircraft-directed data, as illustrated in FIG. 12. Base station 100 then NOMA multiplexes (i.e., superimposes) the aircraft-directed data and the IoT-directed data and transmits them, based on the configured transmission power.

In terminal 200 (e.g., aircraft terminal), the IoT-directed data having the high power may be an interference signal with respect to the aircraft-directed data having the low power. Accordingly, terminal 200 removes a signal component (i.e., interference signal component) of the IoT-directed data from the signal transmitted from base station 100 (S105 in FIG. 11), demodulates and decodes the signal resulting from the interference removal, and thereby extracts the aircraft-directed data (S106 of FIG. 11).

For example, an interference canceller (SIC) may be used to remove the IoT-directed data. As mentioned above, the propagation path between the satellite and the aircraft terminal is substantially the AWGN environment and is less susceptible to the fading. In addition, the transmission power for the IoT-directed data, which is the interference signal with respect to the aircraft terminal, is higher than that for the aircraft-directed data. Thus, terminal 200 can receive the IoT-directed data with high received quality as compared to terminal 300 (e.g., IoT terminal), for example; as a result, the accuracy of the received signal replica can be improved, and the accuracy of the interference removal can be also improved. That is, terminal 200 can appropriately receive the aircraft-directed data.

Meanwhile, in terminal 300 (e.g., IoT terminal), the aircraft-directed data may be the interference signal. However, as illustrated in FIG. 12, the transmission power for the aircraft-directed data is lower than that for the IoT-directed data. For this reason, the aircraft-directed data to be received at terminal 300 may be at a level equivalent to a noise generated in a reception device or neighboring-cell interference. Hence, terminal 300 may perform the reception processing of the data for the IoT terminal (e.g., demodulation and decoding) without performing the interference removal for the aircraft-directed data (S107 in FIG. 11). This reception processing allows terminal 300 to appropriately receive the IoT-directed data.

Next, uplink communication will be described.

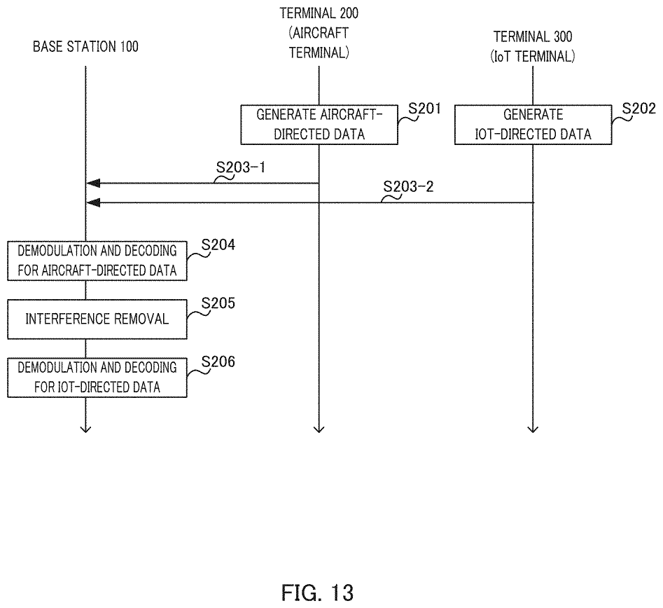

FIG. 13 is a sequence diagram illustrating operation examples of base station 100, terminal 200 (e.g., aircraft terminal), and terminal 300 (e.g., IoT terminal) in the uplink communication.

In FIG. 13, terminal 200 generates the aircraft-directed data (S201). Terminal 300 generates the IoT-directed data (S202). A timing at which the aircraft-directed data and the IoT-directed data are generated respectively in terminal 200 and terminal 300 is not limited to the same timing as illustrated in FIG. 13 and may be different timings from each other.

Terminal 200 transmits the aircraft-directed data to base station 100 (S203-1), and terminal 300 transmits the IoT-directed data to base station 100 (S203-2). These transmissions make the aircraft-directed data and the IoT directed data NOMA multiplexed. Note that, for example, terminal 200 and terminal 300 may perform control regarding the NOMA multiplexing based on control information (not illustrated) including a parameter relating to the NOMA multiplexing such as a transmission timing or a transmission power for each data. Terminal 200 and terminal 300 may be time-synchronized with respect to the data transmission, for example.

For example, base station 100 demodulates and decodes the aircraft-directed data in the received signal (NOMA multiplexed signal) from terminal 200 and terminal 300 (S204).

Further, for example, base station 100 removes an interference signal component (e.g., signal component of the aircraft-directed data) to the IoT directed data from the received signal (S205), demodulates and decodes the signal resulting from the interference removal, and thereby extracts the IoT-directed data (S206). For example, an interference canceller (SIC) may be used to remove the aircraft-directed data.

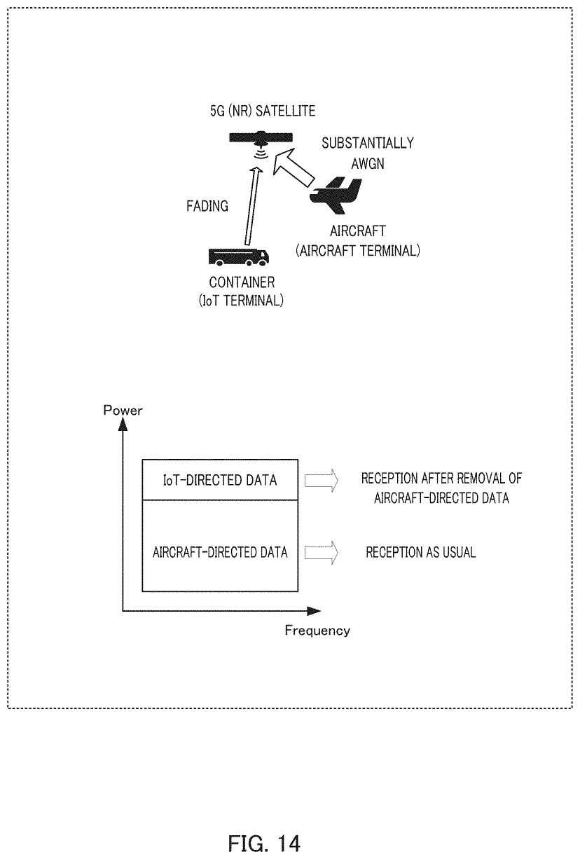

FIG. 14 illustrates an exemplary signal having the aircraft-directed data and the IoT-directed data superimposed thereon to be received in base station 100.

As mentioned above, in the propagation path between a satellite (e.g., 5G (NR) satellite) and an IoT terminal (e.g., container), the satellite easily receives an attenuated or distorted signal due to natural effects such as a cloud or rainfall or effects such as reflected waves on the ground, as compared to the propagation path between the satellite and an aircraft terminal. On the other hand, in the propagation path between the satellite and the aircraft terminal, a masking object or a reflected object is less likely to be present in the surroundings, and thus the satellite easily receives a signal with less attenuation or distortion, as compared to the propagation path between the satellite and the IoT terminal. Further, an antenna of the aircraft generally has output and directivity performance higher than the performance of an antenna of the IoT terminal.

In other words, in the uplink, received quality (e.g., SINR) in the satellite of the signal from the aircraft terminal is likely to be high compared with received quality of the signal from the IoT terminal. Thus, for example, transmission power for the IoT-directed data in terminal 300 may be configured higher than transmission power for the aircraft-directed data in terminal 200 (not illustrated).

Meanwhile, for example, a distance between the satellite and aircraft terminal may assumed to be shorter compared with a distance between the satellite and the IoT terminal (e.g., terminal on the ground). Thus, as illustrated in FIG. 14, received power for the aircraft-directed data in base station 100 can be greater than received power for the IoT-directed directed data.

Hence, the propagation path between the satellite and terminal 200 (aircraft terminal) is substantially the AWGN environment and is less susceptible to the fading, and the received power for the aircraft-directed data, which is an interference signal with respect to the IoT-directed data, is higher than the received power for the IoT-directed data. Thus, base station 100 can receive the aircraft-directed data with received quality higher than that with the IoT-directed data, for example: as a result, the accuracy of the received signal replica can be improved, and the accuracy of the interference removal can be also improved. That is, base station 100 can appropriately receive the IoT-directed data.

Further, in base station 100, the IoT-directed data may be the interference signal with respect to the aircraft-directed data. However, as illustrated in FIG. 14, the received power for the IoT-directed data is lower than that for the aircraft-directed data. For this reason, the IoT-directed data to be received at base station 100 may be at a level equivalent to a noise generated in a reception device or neighboring-cell interference. Hence, base station 100 may perform the reception processing of the aircraft-directed data without performing the interference removal for the IoT-directed data. This reception processing allows terminal 200 to appropriately receive the aircraft-directed data.

As described above, in the present embodiment, in the downlink, base station 100 allocates, in the non-orthogonal multiplexing (e.g., NOMA multiplexing), the first transmission power to the signal corresponding to the communication for IoTs, allocates the second transmission power to the signal corresponding to the communication for aircrafts, and transmits the non-orthogonal multiplexed signal. Further, terminal 200 receives the non-orthogonal multiplexed signal in the downlink and removes, in the non-orthogonal multiplexed signal, the first signal of the first received power (i.e., signal corresponding to different terminal type) corresponding to the communication for IoTs. Further, base station 100 receives the non-orthogonal multiplexed signal in the uplink and removes, in the non-orthogonal multiplexed signal, the second signal of the second received power (i.e., signal of second received power higher than received power corresponding to communication for IoTs) corresponding to the communication for aircrafts.

This processing enables communication of data for respective terminals of different types (e.g., aircraft-directed data and IoT-directed data) in the identical time-and frequency-resources by using the NOMA multiplexing. Thus, for example, the IoT-directed data can be transmitted without reducing the time-and frequency-resources for the aircraft-directed data, and thereby it is made possible to suppress a reduction in data throughput for aircrafts data and to communicate the IoT-directed data. Thus, according to the present embodiment, the transmission efficiency in radio communication systems can be improved.

Additionally, for example, in the interference removal processing in the downlink communication, the IoT-directed data received by terminal 200 (aircraft terminal) is removed, and in the interference removal processing in the uplink communication, the aircraft-directed data received by base station 100 is removed. In other words, in both of downlink communication and uplink communication, the interference removal processing is performed for data to be transmitted and received in the transmission path of the aircraft that is the propagation path having the high transmission and received power and high received quality (substantially AWGN environment) as compared to the transmission path of the IoT terminal. This interference removal processing improves the accuracy of the received signal replica of the interference signal component in both of the downlink communication and uplink communication, and thus, the accuracy of the interference removal can be improved, for example.

Further, in the present embodiment, for example, in the downlink communication, terminal 200 (aircraft terminal) performs the interference removal processing, and in the uplink communication, base station 100 performs the interference removal processing. In other words, terminal 300 (IoT terminal) need not perform the interference removal processing. Thus, for example, it is possible to suppress an increase in the reception processing amount in the IoT terminal such as terminal 200 that can be expected a reduction in size or cost as compared to another terminal.

### Embodiment 2

Configurations of a base station and terminals according to the present embodiment may be common to the configurations of base station 100, terminal 200, and terminal 300 according to Embodiment 1.

In the present embodiment, plural pieces of IoT-directed data are orthogonally multiplexed in the identical time or frequency domain in the identical frame, and a signal in which the plural pieces of IoT-directed data are multiplexed and an aircraft-directed data are non-orthogonal multiplexed (e.g., NOMA multiplexed).

In base station 100 according to the present embodiment, an operation of data transmission processing related to the IoT-directed data is different from that in Embodiment 1.

For example, in base station 100 (FIG. 9), data transmission processor 104 performs transmission processing such as encoding and modulating on the plural pieces of IoT-directed data, and multiplexes the plural pieces of IoT-directed data in the time or frequency domain. For example, in a case of frequency division multiplexing (FDM), data transmission processor 104 may map each kind of IoT-directed data to a resource block (i.e., unit obtained by dividing frequency band into a plurality), which is an example of a different frequency resource. Alternatively, for example, in a case of time division multiplexing (TDM), data transmission processor 104 may map each kind of IoT-directed data to a minislot (i.e., unit obtained by dividing time frame or time slot into a plurality), which is an example of a different time resource. The resource unit to which the IoT-directed data is multiplexed is not limited to the above examples and may be another resource unit.

First, downlink communication will be described.

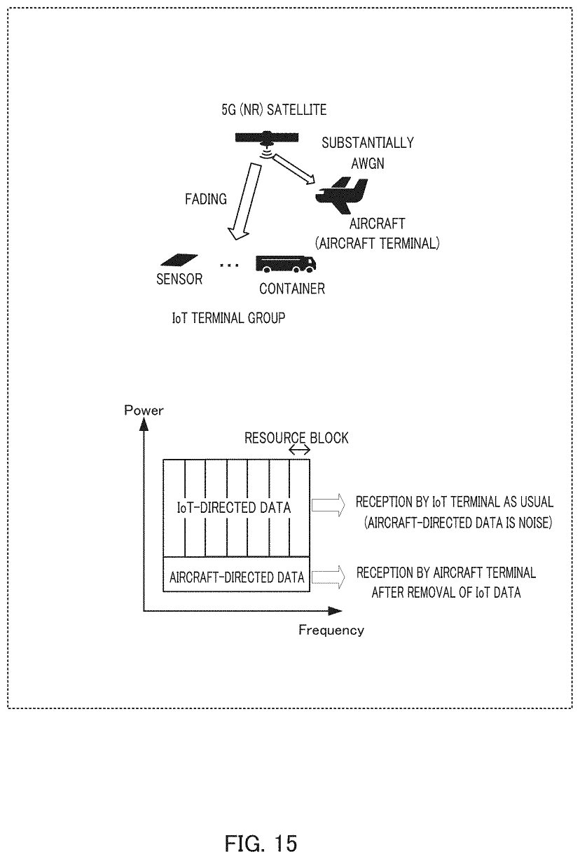

FIG. 15 illustrates an exemplary signal having the aircraft-directed data and the IoT-directed data superimposed thereon to be transmitted in base station 100 in the downlink.

In the example illustrated in FIG. 15, the IoT-directed data is orthogonally multiplexed to different resources in the frequency domain. For example, in 5G NTN, since resource allocation is performed in units of resource blocks, each kind of IoT-directed data may be mapped to different resource blocks.

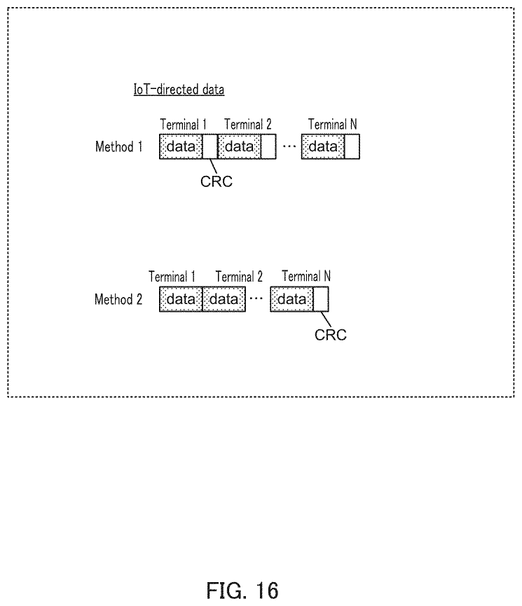

Incidentally, base station 100 may perform encoding and modulation on the plural pieces of IoT-directed data to be orthogonally multiplexed according to, for example, method 1 or method 2 illustrated in FIG. 16.

In method 1 in FIG. 16, base station 100 controls encoding and modulating individually on each kind of IoT-directed data for a plurality of terminals 300 (terminals 1 to N in FIG. 16). For example, as illustrated in FIG. 16, in method 1, a cyclic redundancy check (CRC) bit may be added to the IoT-directed data for each of terminals 1 to N.

In method 1, terminal 200 (e.g., aircraft terminal) performs demodulation, decoding, and replica generation processing on each kind of IoT-directed data being superimposed by NOMA multiplexing, and performs interference removal for the IoT-directed data. Terminal 200 may perform interference removal processing based on, for example, control information such as a modulation scheme or a coding rate for each of terminals 300 (IoT terminals), indicated from base station 100.

Note that, in method 1, each terminal 300 (e.g., IoT terminal) may demodulate and decode the IoT-directed data for terminal 300 itself among the plural pieces of NOMA multiplexed IoT-directed data. That is, in method 1, each terminal 300 need not demodulate and decode the IoT-directed data for other terminals 300.

In method 2 in FIG. 16, base station 100 controls encoding and modulation on a set of plural pieces of the IoT-directed data for a plurality of terminals 300 (terminals 1 to N in FIG. 16). For example, base station 100 may concatenate the plural pieces of the IoT-directed data and may collectively encode and modulate the concatenated data. In one example, as illustrated in FIG. 16, in method 2, a CRC bit may be added to the concatenated data obtained by concatenating the plural pieces of IoT-directed data for the plurality of terminals 1 to N. According to method 2, for example, as compared to method 1, the amount of CRC bits can be reduced while the size of IoT-directed data can be increased, and a coding gain can be thus improved.

In method 2, terminal 200 (e.g., aircraft terminal) may perform demodulation, decoding, and replica generation processing collectively (e.g., once) on the IoT-directed data being superimposed by the NOMA multiplexing and may perform the interference removal for the IoT-directed data. Method 2 allows the processing in terminal 200 to be reduced as compared to method 1.

In method 2, for example, base station 100 may indicate, to terminal 200, one kind of control information such as a modulation scheme or a coding rate for each of a plurality of terminals 300 (IoT terminals). With this indication, in method 2, the informational amount of the control information can be reduced as compared to method 1.

Next, uplink communication will be described.

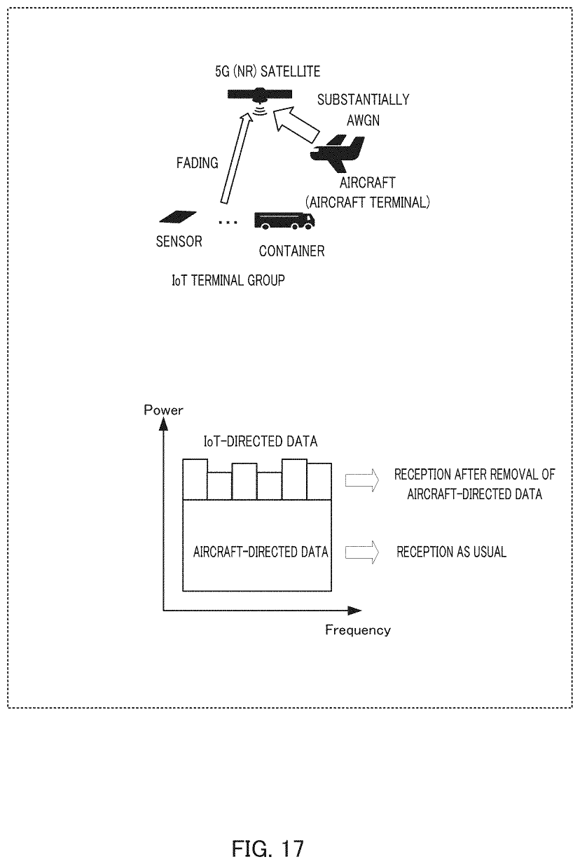

FIG. 17 illustrates an exemplary signal having the aircraft-directed data and the IoT-directed data superimposed thereon to be received in base station 100 in the uplink.

In the example illustrated in FIG. 17, the IoT-directed data is orthogonally multiplexed to different resources in the frequency domain. For example, in 5G NTN, since resource allocation is performed in units of resource blocks, each kind of IoT-directed data may be mapped to different resource blocks.

Further, as illustrated in FIG. 17, since a propagation path is different for each of IoT terminals, received power in base station 100 may also be different for each of the IoT terminals.

In the uplink, base station 100 performs demodulation, decoding, and replica generation processing on, for example, the aircraft-directed data in the reception processing of the IoT-directed data, and performs interference removal for the aircraft-directed data.

Base station 100 then demodulates and decodes of received data from each of the IoT terminals in the received signal where the aircraft-directed data is removed, and thereby obtains the received data for each of the IoT terminals.

Base station 100 may transmit information on resource allocation of the plural pieces of IoT-directed data to be orthogonally multiplexed to terminals 300 (IoT terminals).

For example, base station 100 may individually transmit information on the resource allocation to each of terminals 300.

Alternatively, for example, base station 100 may collectively transmit information on the resource allocation to a plurality of terminals 300 to be orthogonally multiplexed. Base station 100 may transmit information on the resource allocation by, for example, a Group Common Downlink Control Information (DCI). In this case, base station 100 may indicate the one kind of control information to a plurality of terminals 300.

Alternatively, for example, base station 100 may indicate in advance, to terminals 300, a resource block to be allocated to each of terminals 300. In one example, base station 100 may indicate a transmission timing of the uplink signal by means of the DCI. In this case, the resource allocation information for the plurality of IoT terminals is unnecessary to be included in the DCI for each time of allocation, and thus, the number of information bits (i.e., overheads) for indication can be reduced.

As illustrated in FIGS. 15 and 17, the plural pieces of IoT-directed data are orthogonally multiplexed in the frequency domain and non-orthogonally multiplexed with the aircraft-directed data. With this multiplexing, the IoT terminal is required to extract only, for example, the IoT-directed data allocated to orthogonal resources, respectively. In other words, it is unnecessary to perform the interference removal processing between the IoT terminals. Similar to Embodiment 1, the IoT terminal need not perform the interference removal processing for the aircraft-directed data in the NOMA multiplexing. Thus, according to the present embodiment, it is possible to suppress an increase in the reception processing amount of the IoT terminal and to multiplex data for more IoTs to data for one aircraft. As a result, according to the present embodiment, the transmission efficiency in the radio communications can be improved.

The FDM has been described in FIGS. 15 and 17; however, the resource (i.e., orthogonal resource) in which a plural pieces of IoT-directed data are multiplexed is not limited to the frequency resource and may be another resource. For example, the plural pieces of IoT-directed data may be subjected to TDM or Code Division Multiplexing (CDM).

In the present embodiment, a case has been described where a plural pieces of IoT-directed data are orthogonally multiplexed, but the present disclosure is not limited to this case, and signals for a plurality of terminals may be orthogonally multiplexed in at least one of the communication for IoTs and the communication for aircrafts. For example, a signal in which the plural pieces of aircraft-directed data are orthogonally multiplexed (e.g., FDM, TDM or CDM) and the IoT-directed data may be NOMA multiplexed.

The embodiments of the present disclosure have been each described above.

### Other Embodiments

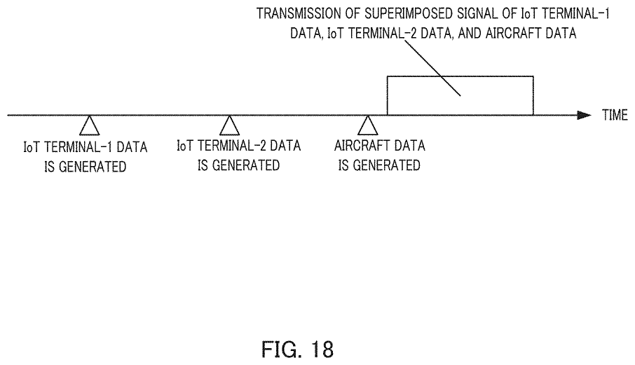

1. In the embodiments mentioned above, for example, a variation may occur in the generation timing of communication traffic for each of aircraft terminal (e.g., terminal 200) and IoT terminal (e.g., terminal 300). Hence, for example, as illustrated in FIG. 18, even when the data for the IoT terminal is generated, base station 100, terminal 200, or terminal 300 may perform multiplexed transmission after a standby until the data for the aircraft terminal is generated. In other words, IoT-directed data that has been generated prior to a transmission timing of the aircraft-directed data may be NOMA multiplexed (non-orthogonal multiplexed) at the transmission timing of the aircraft-directed data.

In FIG. 18, for example, even when data is generated for IoT terminal-1 and IoT terminal-2, these kinds of data are superimposed and transmitted at the timing of generation of the data for the aircraft terminal.

For example, in the downlink, when the IoT-directed data is generated, base station 100 may perform data allocation for both of the IoT terminal and the aircraft terminal after the standby until the aircraft-directed data is generated.

Further, for example, in the uplink, when receiving a scheduling request from terminal 300 (IoT terminal), base station 100 may perform data allocation for both of terminal 200 and terminal 300 after a standby until receiving a scheduling request from terminal 200 (aircraft terminal). The scheduling request is a signal to indicate, to base station 100, that uplink data is present in terminal 200 or terminal 300.

This processing limits interference on other cells caused by at least one of the IoT-directed data and the aircraft-directed data within a local time-or frequency-resource, and the effects of interference on other cells can be thus reduced. Incidentally, in the processing illustrated in FIG. 18, a delay occurs in the transmission of the IoT-directed data. In general, however, the IoT-directed data is not required to be transmitted immediately, and thus, effects of the delay in the IoT-directed data is not considerable. Note that, the processing illustrated in FIG. 18 may be applied to, for example, a terminal in which the delay is allowed.

2. In the embodiments mentioned above, communications in both of the downlink and the uplink have been described, but an exemplary embodiment of the present disclosure may be applied to either of the downlink or the uplink. For example, an exemplary embodiment of the present disclosure may be applied to, of the downlink and the uplink, the uplink where IoT traffic is more likely to be generated.

3. In the embodiments mentioned above, a case has been described where the IoT-directed data is multiplexed to the entire band of resources allocated to the aircraft-directed data (e.g., FIG. 12, 14, 15, or 17), but the present disclosure is not limited to this case. For example, data for IoT terminals may be multiplexed in a part of the bands of the resources allocated to the aircraft-directed data.

3. NOMA has greater effects (e.g., effects of improving accuracy of interference removal) in case of, for example, multiplexing between terminals with differences in propagation attenuation. Thus, among a plurality of IoT terminals, an IoT terminal in a poor propagation environment and an aircraft terminal may be NOMA multiplexed, and an IoT terminal in a good propagation environment may not be NOMA multiplexed.

For example, a cell formed by the satellite can be configured to have a radius of, for example, several hundred kilometers. For this reason, in the cell of the satellite, a terminal susceptible to natural effects such as a cloud or rainfall and a terminal unsusceptible to these may coexist depending on a location of terminal 300 on the ground. Accordingly, for example, an aircraft unsusceptible to natural effects such as a cloud or rainfall (terminal 200) and an IoT terminal susceptible to natural effects such as a cloud or rainfall (terminal 300) may be NOMA multiplexed. In other words, an IoT terminal unsusceptible to natural effects such as a cloud or rainfall (terminal 300) may not be NOMA multiplexed. A presence of a cloud may be determined by a radar from the satellite, and weather information may be indicated to base station 100 from the aircraft or the IoT terminals.

4. An altitude of the aircraft may cause a variation in a propagation path condition between the satellite and the aircraft. For example, at an altitude of eight to 10 km where stable flight is achieved, the propagation path between the satellite and aircraft is in a good propagation environment without being obstructed by a cloud whereas at a low altitude of less than eight kilometers, attenuation may be generated due to a cloud. Thus, base station 100 may determine whether to perform the NOMA multiplexing based on the altitude of the aircraft (or terminal 200). For example, base station 100 may determine to perform the NOMA multiplexing when the altitude of the aircraft is eight kilometers or more, and not to perform the NOMA multiplexing when the altitude of the aircraft is less than eight kilometers. Incidentally, information on the altitude of the aircraft may be indicated from the aircraft (or terminal 200) to base station 100.

5. In the embodiments mentioned above, each terminal (e.g., terminal 200 or terminal 300) may indicate, to base station 100, information on a terminal type such as an IoT terminal or an aircraft terminal. The information on the terminal type may be indicated, for example, at the timing of initial connection. This indication allows base station 100 to distinguish the type of terminal being NOMA multiplexed.

6. In the embodiments mentioned above, the satellite communication system may be configured such that a function of base station 100 is present on the satellite (e.g., “regenerative satellite”) or may be configured such that the function of base station 100 is present on a gateway (GW) on the ground and the satellite relays a signal from the GW (e.g., “transparent satellite”).

7. In the embodiments mentioned above, the satellite communication environment has been described as an example of an NTN environment, but the present disclosure is not limited to this. For example, an exemplary embodiment of the present disclosure may be applied to non-terrestrial communication such as a pseudo-satellite at altitudes of several tens kilometers, a HAPS, or a drone.

Note that, the embodiments mentioned above have been described by taking the NTN environment (e.g., satellite communication environment) as an example, but the present disclosure is not limited to this. The present disclosure may be applied to other communication environments (e.g., terrestrial cellular environment in LTE and/or NR).

8. In the embodiments mentioned above, the communication for aircraft terminals has been described, but the type of terminal is not limited to this and may be a terminal that performs broadband communication, for example. In one example, an exemplary embodiment of the present disclosure may be applied to, instead of the aircraft terminal, for example, a terminal present on a ship, a train, or a flying body different from the aircraft.

In the embodiments mentioned above, the communication for IoT terminals has been described, but the type of terminal is not limited to this and may be a terminal that performs communication of low capacity, for example. In one example, an exemplary embodiment of the present disclosure may be applied to, instead of the IoT terminal, an IoT gateway that performs communication by bundling multiple terminals.

In the embodiments mentioned above, the example of the non-orthogonal multiplexing between the aircraft terminal and the IoT terminal has been described, the terminal type to be non-orthogonally multiplexed is not limited to the combination of the aircraft terminal and the IoT terminal and may be, for example, combinations of the following other terminal types:
a: A terminal used in a fading environment and a terminal not used in the fading environment;
b: A terminal used in a multipath (reflected object) environment and a terminal not used in the multipath environment;
c: A terminal used in a non-line-of-sight environment and a terminal used in line-of-sight environment;
d: A terminal with poor performance (e.g., hardware performance) of at least one of transmission/reception and an antenna and a terminal with good hardware performance;
e: A mobile terminal and a stationary terminal; and
f: A terrestrial terminal and a terminal non-terrestrial terminal.

For example, the terminal used in the fading environment, the terminal used in the multipath environment, the terminal used in the non-line-of-sight environment, the terminal with poor performance, and the mobile terminal may correspond to a terminal prone to quality-deterioration of the propagation path, as in the IoT terminals in the embodiments mentioned above. On the other hand, for example, the terminal that is not used in the fading environment, the terminal not used in the multipath environment, the terminal that is used in the line-of-sight environment, the terminal with good performance, the stationary terminal, and the non-ground terminal may correspond to a terminal having a good quality in the propagation path, as in the aircraft terminal in the embodiments mentioned above.

Further, the performance of the terminal may be distinguished based on, for example, information such as UE capability, UE category, or UE class.

9. In the embodiments mentioned above, a case has been described where, in the NOMA multiplexing, the high transmission power is configured for the IoT-directed data whereas the low transmission power is configured for the aircraft-directed data, and the interference removal processing is performed for the signal corresponding to the propagation path of the aircraft. An exemplary embodiment of the present disclosure is not limited to this case, however, and the transmission power configuration and the interference removal processing may be controlled based on an environmental (or received quality) of each of the terminals to be NOMA multiplexed, for example.

In one example, regarding two terminals to be NOMA multiplexed, a propagation path quality of the terminal that is closer to the satellite may be lower than a propagation path quality of the terminal that is farther away from the satellite. In this case, a high transmission power is configured for the terminal having the lower propagation path quality whereas a low transmission power is configured for the terminal having the higher propagation path quality, and the interference removal processing may be performed for the signal corresponding to the terminal having the higher propagation path quality.

By way of example, a situation will be described where the aircraft enters a cloud and no cloud is present in the sky above the IoT terminal in a cell of the satellite. In this situation, the propagation path quality between the satellite and the IoT terminal may be higher than that of the propagation path between the satellite and the aircraft terminal, for example. In this case, in the NOMA multiplexing, a high transmission power is configured for the aircraft-directed data whereas a low transmission power is configured for the IoT-directed data, and the interference removal processing may be performed for the signal corresponding to the propagation path of the IoT-directed data. Further, in this case, the IoT terminal may include an interference remover.

10. In the embodiments mentioned above, the aircraft-directed data may be transmitted based on, for example, the specification of NR. The IoT-directed data may also be transmitted based on, for example, the specification of LTE NB-IoT or eMTC, or the specification thereof extend to NTN.

11. In the embodiments mentioned above, a case has been described where the non-orthogonal multiplexing is performed in the terminals of different services (e.g., communication for IoTs and communication for aircrafts), but an exemplary embodiment of the present disclosure is not limited to this case, and the non-orthogonal multiplexing may be performed between terminals of the identical service. In one example, the NOMA multiplexing may be performed, in either of communication for IoTs or communication for aircrafts (i.e., the identical service), between the signals of the terminals distinguished by any of a to f described above.

In this case, for example, as in Embodiment 2, at least one of the signals to be NOMA multiplexed may be orthogonally multiplexed (e.g., FDM, TDM, or CDM).

In NOMA, a received signal replica is generated using the decoded data during the interference removal processing by the SIC; however, an accurate replica cannot be generated when a decoding error occurs. When HARQ is used, a packet error rate which is a target in the physical layer may be configured to be higher so as to obtain the gain caused by a retransmission combining. In this case, the number of decoding errors increases, and the accuracy of the replica may be deteriorated. Meanwhile, in NTN, invalidation of HARQ has been discussed due to the long propagation delay thereof. Consequently, the NOMA multiplexing may be applied to a terminal or HARQ process with invalid HARQ whereas the NOMA multiplexing may not be applied to a terminal or HARQ process with valid HARQ. Alternatively, HARQ may be invalidated when performing the NOMA multiplexing,

12. In the embodiments mentioned above, the case has been described of the non-orthogonal multiplexing transmission between the terminals using the identical antenna of the identical satellite in the downlink, but the present disclosure is not limited to this case, and the non-orthogonal multiplexing transmission may be performed for transmission signals from different satellites or different antennae. Additionally, in the uplink, non-orthogonally multiplexed signals from different terminals may be received by the different satellites or the different antennas, respectively.

The other embodiments have been each described above.

Further, the term “terminal” in each of the embodiments described above may be replaced with the term “UE.” Further, the term “base station” may be replaced with the term “eNodeB,” “eNB,” “gNodeB,” or “gNB.”

In addition, the term, such as “part” or “portion” or the term ending with a suffix, such as “-er” “-or” or “-ar” in the above-described embodiment may be replaced with another term, such as “circuit (circuitry),” “device,” “unit,” or “module.”

The present disclosure can be realized by software, hardware, or software in cooperation with hardware. Each functional block used in the description of each embodiment described above can be partly or entirely realized by an LSI such as an integrated circuit, and each process described in the each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI herein may be referred to as an IC, a system LSI, a super LSI, or an ultra LSI depending on a difference in the degree of integration.

However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing.

If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus. The communication apparatus may comprise a transceiver and processing/control circuitry.

The transceiver may comprise and/or function as a receiver and a transmitter. The transceiver, as the transmitter and receiver, may include an RF (radio frequency) module and one or more antennas. The RF module may include an amplifier, an RF modulator/demodulator, or the like. Some non-limiting examples of such a communication apparatus include a phone (e.g., cellular (cell) phone, smart phone), a tablet, a personal computer (PC) (e.g., laptop, desktop, netbook), a camera (e.g., digital still/video camera), a digital player (digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT).”

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as, e.g., a base station, an access point, and any other apparatus, device or system that communicates with or controls apparatuses such as those in the above non-limiting examples.

A communication apparatus according to an exemplary embodiment of the present disclosure includes: control circuitry, which, in operation, allocates, in non-orthogonal multiplexing, first transmission power and second transmission power to a first signal and a second signal, respectively, the first signal corresponding to a first terminal type, the second signal corresponding to a second terminal type; and transmission circuitry, which, in operation, transmits the first signal and the second signal that are non-orthogonally multiplexed.

In an exemplary embodiment of the present disclosure, the first transmission power is higher than the second transmission power.

In an exemplary embodiment of the present disclosure, the transmission circuitry performs at least one of orthogonal multiplexing of a plurality of the first signals and/or orthogonal multiplexing of a plurality of the second signals.

In an exemplary embodiment of the present disclosure, the control circuitry controls encoding and modulation on each of the plurality of the signals to be orthogonally multiplexed.

In an exemplary embodiment of the present disclosure, the control circuitry controls encoding and modulation on a set of the plurality of the signals to be orthogonally multiplexed.

In an exemplary embodiment of the present disclosure, the control circuitry non-orthogonally multiplexes, in a transmission timing of the second signal, the first signal that has been generated prior to the transmission timing of the second signal.

In an exemplary embodiment of the present disclosure, the first terminal type indicates an Internet of Things (IoT) terminal that performs satellite communication, and the second terminal type indicates a terminal that performs satellite communication in a flying body.

A communication apparatus according to an exemplary embodiment of the present disclosure includes: reception circuitry, which, in operation, receives a non-orthogonally multiplexed signal; and control circuitry, which, in operation, removes, in the non-orthogonally multiplexed signal, either one first signal of first received power or a second signal of second received power, the first signal corresponding to a first terminal type, the second signal corresponding to a second terminal type.

In an exemplary embodiment of the present disclosure, the control circuitry removes the second signal of the second received power that is higher than the first received power.

In an exemplary embodiment of the present disclosure, the control circuitry removes the first signal in a case where the communication apparatus is a terminal of the second terminal type.

A communication method according to an exemplary embodiment of the present disclosure includes: allocating, by a communication apparatus, in non-orthogonal multiplexing, first transmission power and second transmission power to a first signal and a second signal, respectively, the first signal corresponding to a first terminal type, the second signal corresponding to a second terminal type; and transmitting, by the communication apparatus, the first signal and the second signal that are non-orthogonally multiplexed.

A communication method according to an exemplary embodiment of the present disclosure includes: receiving, by a communication apparatus, a non-orthogonally multiplexed signal; and removing, by the communication apparatus, in the non-orthogonally multiplexed signal, either one of a first signal of first received power or a second signal of second received power, the first signal corresponding to a first terminal type, the second signal corresponding to a second terminal type.

The disclosure of Japanese Patent Application No. 2019-236799 filed on Dec. 26, 2019 including the specification, drawings and abstract is incorporated herein by reference in its entirety.

### Industrial Applicability

An aspect of the present disclosure is useful for radio communication systems.

### REFERENCE SIGNS LIST

100 Base station

101, 103, 205, 305 Data generator

107, 104, 206, 306 Data transmission processor

105 NOMA multiplexer

106 Control information. generator

107 Control information transmission processor

108, 207, 307 Radio transmitter

109, 201, 301 Antenna

110, 202, 302 Radio receiver

111 Reception processor

200, 300 Terminal

203, 303 Control information reception processor

204, 304 Data reception processor

1. A communication apparatus, comprising:
control circuitry, which, in operation, allocates, in non-orthogonal multiplexing, first transmission power and second transmission power to a first signal and a second signal, respectively, the first signal corresponding to a first terminal type, the second signal corresponding to a second terminal type; and
transmission circuitry, which, in operation, transmits the first signal and the second signal that are non-orthogonally multiplexed.

2. The communication apparatus according to claim 1, wherein the first transmission power is higher than the second transmission power.

3. The communication apparatus according to claim 1, wherein the transmission circuitry performs at least one of orthogonal multiplexing of a plurality of the first signals and/or orthogonal multiplexing of a plurality of the second signals.

4. The communication apparatus according to claim 3, wherein the control circuitry controls encoding and modulation on each of the plurality of the signals to be orthogonally multiplexed.

5. The communication apparatus according to claim 3, wherein the control circuitry controls encoding and modulation on a set of the plurality of the signals to be orthogonally multiplexed.

6. The communication apparatus according to claim 1, wherein the control circuitry non-orthogonally multiplexes, in a transmission timing of the second signal, the first signal that has been generated prior to the transmission timing of the second signal.

7. The communication apparatus according to claim 1, wherein:
the first terminal type indicates an Internet of Things (IoT) terminal that performs satellite communication, and
the second terminal type indicates a terminal that performs satellite communication in a flying body.

8. A communication apparatus, comprising:
reception circuitry, which, in operation, receives a non-orthogonally multiplexed signal; and
control circuitry, which, in operation, removes, in the non-orthogonally multiplexed signal, either one of a first signal of first received power or a second signal of second received power, the first signal corresponding to a first terminal type, the second signal corresponding to a second terminal type.

9. The communication apparatus according to claim 8, wherein the control circuitry removes the second signal of the second received power that is higher than the first received power.

10. The communication apparatus according to claim 8, wherein the control circuitry removes the first signal in a case where the communication apparatus is a terminal of the second terminal type.

11. The communication apparatus according to claim 8, wherein:
the first terminal type indicates an Internet of Things (IoT) terminal that performs satellite communication, and
the second terminal type indicates a terminal that performs satellite communication in an aircraft.

12. A communication method, comprising:
allocating, by a communication apparatus, in non-orthogonal multiplexing, first transmission power and second transmission power to a first signal and a second signal, respectively, the first signal corresponding to a first terminal type, the second signal corresponding to a second terminal type; and
transmitting, by the communication apparatus, the first signal and the second signal that are non-orthogonally multiplexed.

13. A communication method, comprising:
receiving, by a communication apparatus, a non-orthogonally multiplexed signal; and
removing, by the communication apparatus, in the non-orthogonally multiplexed signal, either one of a first signal of first received power or a second signal of second received power, the first signal corresponding to a first terminal type, the second signal corresponding to a second terminal type.
